(19) United States
(12) Patent Application Publication
(10) Pub. No.: US 2026/0121989 A1
(43) Pub. Date: Apr. 30, 2026

(54) METHOD AND NETWORK SYSTEM FOR SETTING DATA PATH MODE AND DATAFLOW PRIORITY FOR TERMINAL DEVICE

(71) Applicant: HITRON TECHNOLOGIES INC., HSINCHU (TW)

(72) Inventors: CHUXIN LI, HSINCHU (TW); LI LU, HSINCHU (TW); XINHUAI LI, HSINCHU (TW)

(21) Appl. No.: 19/098,189

(22) Filed: Apr. 2, 2025

(30) Foreign Application Priority Data
Oct. 28, 2024 (CN) 202411514276.1

(51) Int. Cl. H04L 47/24; H04W 76/11

(52) U.S. Cl. CPC H04L 47/24; H04W 76/11

(57) ABSTRACT

A method of setting a data path mode and dataflow priority for a terminal device is to be implemented by a network system. The network system supports a plurality of data path modes and stores a set of mode matching rules. The method includes: receiving identification data from the terminal device; selecting a target data path mode from among the data path modes according to the set of mode matching rules and the identification data thus received; operating in the target data path mode for processing a dataflow of the terminal device; and in response to receipt of a data packet from the terminal device, obtaining a priority level for the dataflow of the terminal device based on a set of dataflow priority rules and the data packet thus received.

### CROSS-REFERENCE TO RELATED APPLICATION

This application claims priority to Chinese Invention patent application No. 202411514276.1, filed on Oct. 28, 2024, the entire disclosure of which is incorporated by reference herein.

### FIELD

The disclosure relates to a method and a network system for setting a data path mode and dataflow priority for a terminal device.

### BACKGROUND

A conventional router supports a plurality of data path modes such as a bridging mode, a network address translation (NAT) mode, or a tunneling mode. When a terminal device is connected to the conventional router via Ethernet or a wireless network (identified by a Service Set Identifier (SSID)), the conventional router has to be manually configured to operate in one of the data path modes that is compatible with the terminal device. When a connection between the conventional router and the terminal device is lost and then reestablished, or when a different terminal device is connected to the conventional router, the conventional router has to be manually reconfigured. Repeated manual configuration of the conventional router is time and energy consuming. Furthermore, given that network resources are limited, proper allocation of network resources is crucial, especially when multiple terminal devices are involved.

### SUMMARY

Therefore, an object of the disclosure is to provide a method and a network system for setting a data path mode and dataflow priority for a terminal device that can alleviate at least one of the drawbacks of the prior art.

According to an aspect of the disclosure, the method is to be implemented by a network system. The network system supports a plurality of data path modes and stores a set of mode matching rules. The method includes: receiving identification data from the terminal device; selecting a target data path mode from among the data path modes according to the set of mode matching rules and the identification data thus received; operating in the target data path mode for processing a dataflow of the terminal device; and in response to receipt of a data packet from the terminal device, obtaining a priority level for the dataflow of the terminal device based on a set of dataflow priority rules and the data packet thus received.

According to another aspect of the disclosure, the network system includes a router, and a network access equipment that is connected to the router. The router is configured to support a plurality of data path modes and store a set of mode matching rules. The router is further configured to receive identification data from the terminal device, select a target data path mode from among the data path modes according to the set of mode matching rules and the identification data thus received, and operate in the target data path mode for processing a dataflow of the terminal device. The router or the network access equipment is configured to, in response to receipt of a data packet from the terminal device, obtain a priority level for the dataflow of the terminal device based on a set of dataflow priority rules and the data packet thus received.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram of a network system for setting a data path mode and dataflow priority for a terminal device according to an embodiment of the present disclosure.

FIG. 2 is a flow chart illustrating a first procedure for setting a data path mode for a terminal device according to an embodiment of this disclosure.

FIG. 3 is a flow chart illustrating a second procedure for setting dataflow priority for a terminal device according to an embodiment of this disclosure.

FIG. 4 is a flow chart illustrating the second procedure for setting dataflow priority for a terminal device according to another embodiment of this disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

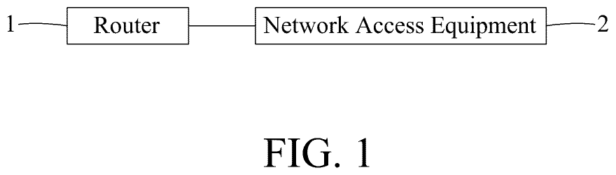

Referring to FIG. 1, a network system for setting a data path mode and dataflow priority for a terminal device according to an embodiment of this disclosure is presented. In this embodiment, the network system includes a router 1 and a network access equipment 2. The network access equipment 2 is exemplified by a modem (e.g., a digital subscriber line (DSL) modem, a fiber optic modem, a cable modem, a cellular modem, a satellite modem, etc.), a network switch, a gateway or a hub, but is not limited to thus. The router 1 and the network access equipment 2 are connected to each other via, for example, but not limited to, Ethernet, fiber optics, or a wireless network.

The router 1 supports a plurality of data path modes and is configured to allow a terminal device (not shown) to be connected thereto. The data path modes include, for example, but not limited to, a bridging mode, a network address translation (NAT) mode, and a tunneling mode. In one embodiment, the terminal device is exemplified by a device that can connect to the Internet such as a smart phone, a notebook computer, and a television set-top box; however the terminal device is not limited to thus. The router 1 stores a set of mode matching rules that designates that a plurality of designated modes are to be associated respectively with a plurality of designated device types, and that a default mode is to be associated with an undesignated device type. Each of the designated modes and the default mode is one of the data path modes. In some embodiments, rather than being associated with an undesignated device type the default mode may be associated with some of the designated device types, and the disclosure is not limited in this respect.

For example, the set of mode matching rules includes designating that a plurality of designated vendor class identifiers (VCIs) are to correspond respectively to the designated device types. That is to say, the designated VCIs are associated respectively to the designated modes. The set of mode matching rules designates that, for each of the designated VCIs, an associating one of the designated modes is associated with the designated VCI. More specifically, the set of mode matching rules designates that, for one of the designated VCIs that indicates a device type of “IPTV”, the associating one of the designated modes is the bridging mode, and for another one of the designated VCIs that indicates a device type of “PHONE”, the associating one of the designated modes is the tunneling mode. The set of mode matching rules further designates that, for an undesignated VCI that is not any one of the designated VCIs, the undesignated VCI is determined as indicating the undesignated device type and is associated with the default mode. In some embodiments, the set of mode matching rules may designate that, when the undesignated VCI is determined as indicating the undesignated device type, the router 1 does not allow the terminal device currently connected to the router 1 to access the router 1, and discards any data received from the terminal device; however, the disclosure is not limited in this respect. In one embodiment, the default mode associated with the undesignated device type is the NAT mode, but the default mode is not limited to such.

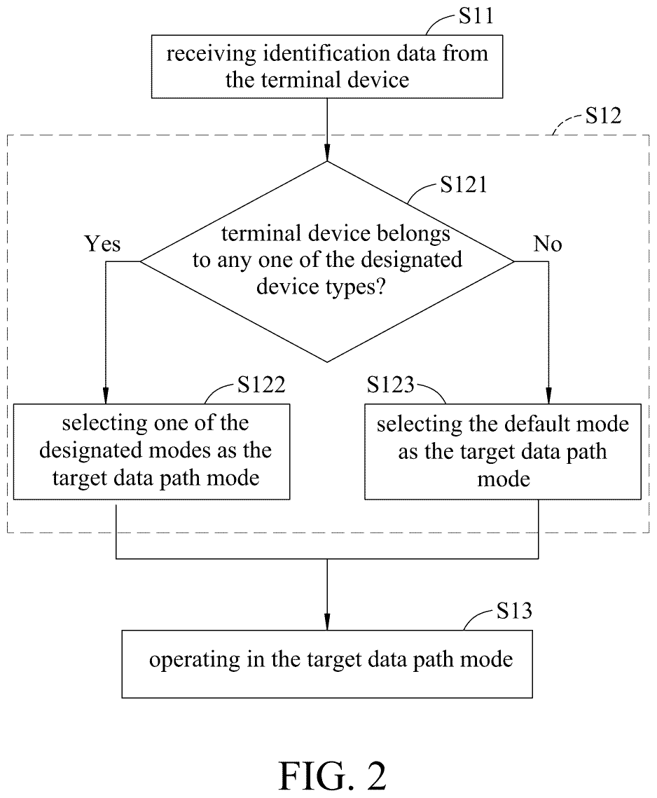

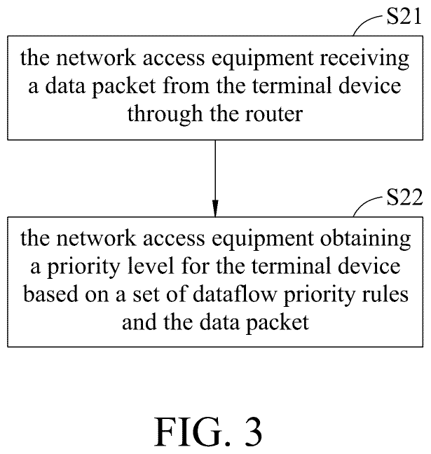

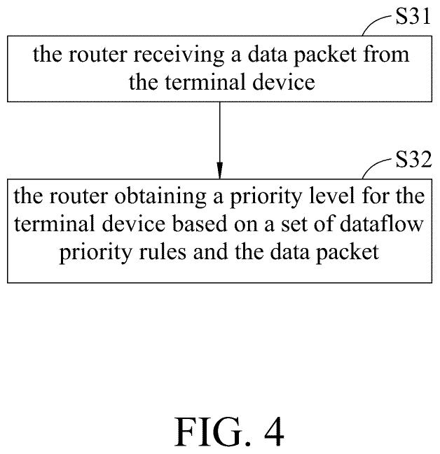

Referring to FIG. 2, an embodiment of a method for setting a data path mode and dataflow priority for a terminal device is provided according to an embodiment of this disclosure. The method is, for example, implemented by the network system of FIG. 1, and includes a first procedure for setting a data path mode for a terminal device (see FIG. 2), and a second procedure for setting dataflow priority for a terminal device (see FIG. 3 or 4). The first procedure of the method for setting a data path mode for a terminal device includes steps S11 to S13.

In step S11, upon being connected to a terminal device, the router 1 receives identification data from the terminal device. In one embodiment, the identification data at least includes a VCI of the terminal device. In some embodiments, the identification data may further include, for example, the Internet Protocol (IP) address, the media access control (MAC) address, and the hostname of the terminal device; however, the identification data is not limited in this respect.

Specifically, when the router 1 is connected to the terminal device, the router 1 receives the identification data that is transmitted by the terminal device in a request message. The terminal device transmits the request message using a standard or proprietary network protocol, such as Dynamic Host Configuration Protocol (DHCP), Internet Protocol version 6 (IPv6) of the DHCP commonly called DHCPv6, Universal Plug and Play (UPnP), Multicast Domain Name System (mDNS) or NetBIOS Name Service (NBNS), among others. Proprietary network protocols may include those used by customer-premises equipment (CPE), such as vendor-specific layer 2 protocols, but the disclosure is not limited in this respect.

In step S12, the router 1 selects a target data path mode from among the data path modes that are supported by the router 1 according to the set of mode matching rules and the identification data thus received. In this embodiment, step S12 includes sub-steps S121 to S123.

In sub-step S121, the router 1 determines whether the terminal device belongs to any one of the designated device types based on the set of mode matching rules and the identification data. When the determination is affirmative, the flow goes to S122. The flow goes to S123 when the determination is negative.

For example, when the terminal device is connected to the router 1, the terminal device transmits the request message using the DHCP to the router 1. The request message includes information that includes DHCP Option 60. The DHCP Option 60 is used to define the VCI of the terminal device, and the router 1 can obtain the VCI of the terminal device from the DHCP Option 60. The VCI of the terminal device indicates a device type of the terminal device. When the router 1 determines that the device type indicated by the VCI of the terminal device belongs to one of the designated device types, the flow goes to S122. The flow goes to S123 when the router 1 determines that the device type indicated by the VCI of the terminal device does not belong to any one of the designated device types. Specifically, when the router 1 determines that the VCI of the terminal device matches with one of the designated VCIs included in the set of mode matching rules, the router 1 determines that the terminal device belongs to one of the designated device types, and the flow goes to S122; when the router 1 determines that the VCI of the terminal device does not match any one of the designated VCIs included in the set of mode matching rules, the router 1 determines that the terminal device is the undesignated device type, and the flow goes to S123.

In sub-step S122, the router 1 selects one of the designated modes that is associated with said one of the designated device types as the target data path mode. Specifically, said one of the designated device types is the designated device type that corresponds to the designated VCI matching the VCI of the terminal device, and the target data path mode is the designated mode that is associated with the designated VCI matching the VCI of the terminal device.

For example, when the VCI of the terminal device indicates the device type of “IPTV”, the router 1 determines that the VCI of the terminal device matches with one of the designated VCIs included in the set of mode matching rules (i.e., the “IPTV” included in the set of mode matching rules), and selects the bridging mode (i.e., the associating one of the designated modes) as the target data path mode. In some embodiments, the router 1 further stores the MAC address of the terminal device.

In sub-step S123, the router 1 selects the default mode that is associated with the undesignated device type as the target data path mode.

For example, when the VCI of the terminal device indicates a device type of “LAPTOP”, and the router 1 determines that “LAPTOP” does not match any one of the designated device types associated with the designated VCIs in the set of mode matching rules, the router 1 determines that the terminal device belongs to the undesignated device type, and selects the default mode (i.e., the NAT mode in this embodiment) as the target data path mode.

In step S13, the router 1 operates in the target data path mode for processing a dataflow of the terminal device.

Referring to FIG. 3, the second procedure for setting dataflow priority for a terminal device according to an embodiment is provided. The second procedure is implemented, for example, by the network system of FIG. 1 according to this disclosure. The second procedure for setting dataflow priority for a terminal device includes steps S21 to S22.

In step S21, the network access equipment 2 receives a data packet from a terminal device through the router 1.

In step S22, the network access equipment 2, in response to receipt of the data packet, obtains a priority level for the dataflow of the terminal device based on a set of dataflow priority rules and the data packet thus received. In one embodiment, the set of dataflow priority rules is pre-stored in the network access equipment 2. In other embodiments, the set of dataflow priority rules may be transmitted to the network access equipment 2 by for example, but not limited to, the router 1 or a cloud server (not shown). The set of dataflow priority rules designates a plurality of different predetermined levels, and designates that a plurality of matching requirements are to be associated respectively with the different predetermined levels.

For example, each of the matching requirements may be related to a differentiated services code point (DSCP) of the data packet, a protocol type of the data packet, a size of the data packet, an encapsulation status of the data packet, an IP address of the data packet, a MAC address of the data packet, a transmission speed of the data packet, and/or a propagation type of the data packet (e.g., broadcast, multicast or unicast), but the disclosure is not limited to thus.

The data packet includes a packet content that is related to the matching requirements. Specifically, for each predetermined level of the different predetermined levels, the network access equipment 2 determines whether the packet content of the data packet fulfils the corresponding one of the matching requirements that is associated with the predetermined level, and sets the predetermined level as the priority level for the dataflow of the terminal device when determining that the packet content of the data packet fulfils the corresponding one of the plurality of matching requirements. In this embodiment, the packet content of the data packet is configured to fulfil one of the different predetermined levels.

For example, each of the matching requirements is related to the size of a data packet received by the network access equipment 2, a high priority level (i.e., an example of one of the different predetermined levels) is associated with a first one of the matching requirements that a data packet has a packet content size less than a threshold size of 1000 bytes, and a low priority level is associated with a second one of the matching requirements that a data packet has a packet content size greater than the threshold size of 1000 bytes. When the data packet received by the network access equipment 2 includes the packet content that has a size of 2000 bytes, the network access equipment 2 determines that the packet content of the data packet fulfils the second one of the matching requirements, and sets the low priority level as the priority level for the dataflow of the terminal device. It should be noted that the packet content of the data packet must fulfil one of the matching requirements. In some embodiments, the threshold size of the data packet received may be adjusted according to different application scenarios and network environments such as when operating over Ethernet or the Internet, and the disclosure is not limited in this respect.

After the network access equipment 2 has set the priority level for the dataflow of the terminal device, the network access equipment 2 performs network resource allocation based on the priority level thus set for the dataflow of the terminal device.

Referring to FIG. 4, the second procedure for setting dataflow priority for a terminal device according to another embodiment is provided. In this embodiment, the second procedure of the method for setting dataflow priority for a terminal device includes steps S31 to S32. In this embodiment, the second procedure is performed by the router 1 instead of the network access equipment 2, and the set of dataflow priority rules is pre-stored in the router 1.

In step S31, the router 1 receives a data packet from a terminal device that is connected to the router 1.

In step S32, the router 1, in response to receipt of the data packet from the terminal device, obtains the priority level for the dataflow of the terminal device based on the set of dataflow priority rules and the packet content of the data packet. It should be noted that, in this embodiment, the set of dataflow priority rules and the manner for determining the priority level are similarly to those described in the foregoing embodiment with reference to FIG. 3, and details thereof are omitted herein for the sake of brevity.

After the router 1 has set the priority level for the dataflow of the terminal device, the router 1 transmits the priority level for the dataflow of the terminal device to the network access equipment 2, so that the network access equipment 2 may perform network resource allocation based on the priority level for the dataflow of the terminal device.

It should be noted that, in some embodiments, the method for setting dataflow priority for a terminal device may be performed by a computing device (not shown) for example, but not limited to, the cloud server. In such embodiments, the computing device receives the data packet from the terminal device through the router 1, and obtains the priority level for the dataflow of the terminal device based on the set of dataflow priority rules and the packet content of the data packet. The computing device then transmits the priority level for the dataflow of the terminal device thus obtained to the network access equipment 2.

In other words, the network access equipment 2 may obtain the priority level for the dataflow of a terminal device connected to the router 1 either by the network access equipment 2 performing the second procedure for setting dataflow priority for the terminal device, or receiving the priority level for the dataflow of the terminal device from the router 1 or the computing device.

In sum, the router 1 receives the identification data from the terminal device, selects the target data path mode from among the data path modes according to the set of mode matching rules and the identification data thus received, and operates in the target data path mode for processing the dataflow of the terminal device. With the aforementioned configurations, the network system of this disclosure is able to achieve automatic switching among the data path modes of the router 1 based on different terminal devices connected to the router 1, which eliminates the need for a user to manually configure the data path mode each time a different terminal device is connected to the router 1, thereby providing the user with a convenient usage experience. Furthermore, the router 1 or the network access equipment 2, in response to receipt of the data packet from the terminal device, obtains the priority level for the dataflow of the terminal device based on the set of dataflow priority rules and the packet content of the data packet thus received. By way of the aforementioned configurations, the network system of this disclosure is able to achieve automatic setting of the dataflow priority for the different terminal devices, thereby improving efficiency in network resource allocation.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for setting a data path mode and dataflow priority for a terminal device to be implemented by a network system, the network system supporting a plurality of data path modes and storing a set of mode matching rules, said method comprising:
receiving identification data from the terminal device;
selecting a target data path mode from among the plurality of data path modes according to the set of mode matching rules and the identification data thus received;
operating in the target data path mode for processing a dataflow of the terminal device; and
in response to receipt of a data packet from the terminal device, obtaining a priority level for the dataflow of the terminal device based on a set of dataflow priority rules and the data packet thus received.

2. The method as claimed in claim 1, wherein the set of mode matching rules designates that a plurality of designated modes are to be associated respectively with a plurality of designated device types, and that a default mode is to be associated with an undesignated device type, each of the plurality of designated modes and the default mode being one of the plurality of data path modes.

3. The method as claimed in claim 2, wherein selecting the target data path mode includes:
determining whether the terminal device belongs to any one of the plurality of designated device types based on the set of mode matching rules and the identification data;
selecting the default mode as the target data path mode in response to determining that the terminal device does not belong to any one of the plurality of designated device types; and
in response to determining that the terminal device belongs to one of the plurality of designated device types, selecting one of the plurality of designated modes that is associated with said one of the plurality of designated device types as the target data path mode.

4. The method as claimed in claim 3, wherein the identification data at least includes a vendor class identifier (VCI) of the terminal device,
wherein, determining whether the terminal device belongs to any one of the plurality of designated device types is to determine whether a device type indicated by the VCI belongs to any one of the plurality of designated device types.

5. The method as claimed in claim 1, wherein the set of dataflow priority rules designates a plurality of different predetermined levels, and designates that a plurality of matching requirements are to be associated respectively with the plurality of different predetermined levels.

6. The method as claimed in claim 5, wherein the data packet includes a packet content that is related to the plurality of matching requirements,
wherein obtaining the priority level for the dataflow of the terminal device includes, for each predetermined level of the plurality of different predetermined levels,
determining whether the packet content of the data packet fulfils the corresponding one of the plurality of matching requirements that is associated with the predetermined level, and
in response to determining that the packet content of the data packet fulfils the corresponding one of the plurality of matching requirements, setting the predetermined level as the priority level for the dataflow of the terminal device.

7. The method as claimed in claim 1, the network system including a router and that is configured to support the plurality of data path modes and store the set of mode matching rules, and a network access equipment that is connected to the router,
wherein receiving the identification data, selecting the target data path mode, and operating in the target data path mode are implemented by the router, and obtaining the priority level for the dataflow of the terminal device is implemented by the network access equipment.

8. The method as claimed in claim 1, the network system including a router that is configured to support the plurality of data path modes and store the set of mode matching rules,
wherein receiving the identification data, selecting the target data path mode, operating in the target data path mode, and obtaining the priority level for the dataflow of the terminal device are implemented by the router.

9. A network system for setting a data path mode and dataflow priority for a terminal device, said network system comprising:
a router that is configured to support a plurality of data path modes and store a set of mode matching rules, and that is further configured to
receive identification data from the terminal device,
select a target data path mode from among the plurality of data path modes according to the set of mode matching rules and the identification data thus received, and
operate in the target data path mode for processing a dataflow of the terminal device; and
a network access equipment connected to said router,
wherein one of said router and said network access equipment is configured to, in response to receipt of a data packet from the terminal device, obtain a priority level for the dataflow of the terminal device based on a set of dataflow priority rules and the data packet thus received.

10. The network system as claimed in claim 9, wherein the set of mode matching rules designates that a plurality of designated modes are to be associated respectively with a plurality of designated device types, and that a default mode is to be associated with an undesignated device type, each of the plurality of designated modes and the default mode being one of the plurality of data path modes.

11. The network system as claimed in claim 10, wherein said router is configured to select the target data path mode by:
determining whether the terminal device belongs to any one of the plurality of designated device types based on the set of mode matching rules and the identification data;
selecting the default mode as the target data path mode in response to determining that the terminal device does not belong to any one of the plurality of designated device types; and
in response to determining that the terminal device belongs to one of the plurality of designated device types, selecting one of the plurality of designated modes that is associated with said one of the plurality of designated device types as the target data path mode.

12. The network system as claimed in claim 11, wherein the identification data at least includes a vendor class identifier (VCI) of the terminal device,
wherein said router is configured to determine whether the terminal device belongs to any one of the plurality of designated device types by determining whether a device type indicated by the VCI belongs to any one of the plurality of designated device types.

13. The network system as claimed in claim 9, wherein the set of dataflow priority rules designates a plurality of different predetermined levels, and designates that a plurality of matching requirements are to be associated respectively with the plurality of different predetermined levels.

14. The network system as claimed in claim 13, wherein the data packet includes a packet content that is related to the plurality of matching requirements,
wherein one of said router and said network access equipment is configured to obtain the priority level for the dataflow of the terminal device by, for each predetermined level of the plurality of different predetermined levels,
determining whether the packet content of the data packet fulfils the corresponding one of the plurality of matching requirements that is associated with the predetermined level, and
in response to determining that the packet content of the data packet fulfils the corresponding one of the plurality of matching requirements, setting the predetermined level as the priority level for the dataflow of the terminal device.
